(19) United States
(12) Patent Application Publication
(10) Pub. No.: US 2026/0160392 A1
(43) Pub. Date: Jun. 11, 2026

(54) PRESSURE SENSING UNITARY DEVICE

(71) Applicant: ENTEGRIS, INC., Billerica, MA (US)

(72) Inventors: Thines Kumar Perumal, Singapore (SG); Aravind Vasanthakumar, Singapore (SG); Subhash Guddati, Singapore (SG); Montray Leavy, Singapore (SG); Sanado Barolli, Bethlehem, CT (US); Edward E. Jones, Woodbury, CT (US)

(21) Appl. No.: 18/708,580

(22) PCT Filed: Nov. 29, 2022
(86) PCT No.: PCT/US2022/051247

§ 371 Date: May 8, 2024

Related U.S. Application Data
(60) Provisional application No. 63/284,897, filed on Dec. 1, 2021.

(51) Int. Cl. F17C 13/04

(52) U.S. Cl. CPC F17C 13/04; F17C 2205/0338; F17C 2205/0391

(57) ABSTRACT

A high pressure fluid storage system with at least one pressure sensing unitary device (PSUD) which can perform the function of a pressure regulator device. The PSUD can be manufactured as a single unitary construction, wherein both the housing body and the internal pressure regulating mechanism are made from a single unit, material, or both. The PSUD does not have any welded components, is not assembled from a plurality of separate components, or both.

### FIELD

The present disclosure relates to the field of vacuum actuated cylinders (VACs) and subatmospheric pressure gas delivery systems with pressure regulated valves.

### BACKGROUND

Subatmospheric pressure delivery systems, such as VACs, can use a pressure sensing device to regulate opening and closing of valves.

### SUMMARY

A pressure sensing assembly (PSA) generally includes various components assembled and can include various welded components after the assembly. In some PSAs, there can be various (e.g., 17 or more) separate components, made of different materials, assembled together. Assembly of these various components and welding of those components to produce a PSA can lead to inconsistent performances, failures due to poor manufacturing processes and quality control, or both. Further, the various components of the PSA are often manufactured at different locations or by different manufacturers, and the varying tolerances amongst them can lead to the final assembled PSA having inconsistent quality and performances. Inconsistent performances can include, for example, gas spikes, gas pressure oscillations, or both. Failures of PSAs are generally detected during operation. Identifying the specific reasons for such failures in assembled PSAs is difficult because there can be many different components which can be the cause of the failure.

In some embodiments, a device which can replace the PSA is disclosed herein.

Some embodiments of the present disclosure relate to a pressure sensing unitary device (PSUD) which can perform the function of the PSA. In some embodiments, the PSUD is a VAC regulator device. The PSUD can have better consistency in performance than the PSA, and reduce gas spikes, gas pressure oscillations, or both.

Some embodiments of the present disclosure relate to a VAC having a VAC regulator device, wherein the VAC regulator device includes an embodiment of the PSUD. Some embodiments of the present disclosure relate to a VAC having one or more VAC regulator devices, wherein at least one of the VAC regulator devices includes an embodiment of the PSUD.

Some embodiments of the present disclosure relate to a PSUD which does not have any of the manufacturing defects that can be present in the PSA.

Some embodiments of the present disclosure relate to a PSUD which does not have any welded components.

Some embodiments of the present disclosure relate to a PSUD which is not assembled from a plurality of components.

Some embodiments of the present disclosure relate to a PSUD which is a single unitary construction. In some embodiments, the unitary construction can be manufactured via additive manufacturing process(es) (e.g., 3D printing).

In some embodiments, the PSUD is made from a material which is capable of additive manufacturing. In some embodiments, the material is a polymer. In some embodiments, the material is a metal, such as for example, stainless steel. In some embodiments, the material is a composite material, which is a combination of materials.

In some embodiments, the PSUD includes a housing and a pressure reducing mechanism, wherein the housing and the pressure reducing mechanism is a unitary construction, such that the housing and the pressure reducing mechanism is formed of a single unitary body.

In some embodiments, a pressure reducing mechanism includes, at least, bellows, retracting springs, stem, and valve portions. In some embodiments, the single unitary body includes, at least, a portion of a housing and bellows. In some embodiments, the single unitary body includes, one or more of a portion of a housing, bellows, retracting springs, stem, or valve portions. In some embodiments, the single unitary body includes, at least, a housing, bellows, retracting springs, stem, and valve portions. In some embodiments, the valve includes a ball. In some embodiments, the ball (valve) opens and closes via operation of the bellows.

In some embodiments with the bellows, the inlet flows a fluid at a first pressure which causes the bellows to expand, which then allows the fluid to flow in slower into the PSUD. The fluid is then directed to flow towards the outlet at a second pressure, where the second pressure is lower than the first pressure.

As used herein, the term “fluid” includes gas.

In some embodiments, the bellows has a plurality of leaves unitarily constructed along with the housing. Accordingly, there are no welds between the bellows and the housing.

In some embodiments of a device, the device comprises a single unitary body, wherein the single unitary body includes a housing, wherein the housing includes an inlet, and an outlet; and a pressure reducing mechanism, wherein the pressure reducing mechanism is contained within the housing, wherein the pressure reducing mechanism is disposed between the inlet and the outlet, and wherein the pressure reducing mechanism is configured to receive a fluid having an first pressure which enters via the inlet, direct a flow of the fluid towards the outlet at a second pressure.

In some embodiments of a device, the device comprises a single unitary body, wherein the single unitary body includes a housing, wherein the housing includes an inlet, and an outlet; a pressure reducing mechanism, wherein the pressure reducing mechanism is contained within the housing, wherein the pressure reducing mechanism is disposed between the inlet and the outlet, and wherein the pressure reducing mechanism is configured to receive a fluid having an first pressure which enters via the inlet, direct a flow of the fluid towards the outlet at a second pressure; and a second pressure reducing mechanism, wherein the pressure reducing mechanism is contained within the housing, wherein the pressure reducing mechanism is disposed between the pressure reducing mechanism and the outlet, and wherein the pressure reducing mechanism is configured to receive the fluid from the pressure reducing mechanism having the second pressure, and then direct the flow of the fluid towards the outlet at a third pressure.

In some embodiments of the device, the housing and the pressure reducing mechanism does not have any welds or welded components.

In some embodiments of the device, the pressure reducing mechanism includes a bellows portion.

In some embodiments of the device, the single unitary body is made of a stainless steel.

In some embodiments of the device, the first pressure is not subatmospheric pressure.

In some embodiments of the device, the first pressure is higher than subatmospheric pressure.

In some embodiments of the device, the second pressure is subatmospheric pressure.

In some embodiments of the device, the second pressure is lower than the first pressure.

In some embodiments, a device comprises a single unitary body, wherein the single unitary body consists essentially of a housing, wherein the housing includes an inlet, and an outlet; and a pressure reducing mechanism, wherein the pressure reducing mechanism is connected to the housing, wherein the pressure reducing mechanism is contained within the housing, wherein the pressure reducing mechanism is disposed between the inlet and the outlet, and wherein the pressure reducing mechanism is configured to receive a fluid having an first pressure which enters via the inlet, direct a flow of the fluid to the outlet at a second pressure, wherein the second pressure is lower than the first pressure.

In some embodiments, a device comprises a single unitary body, wherein the single unitary body consists of a housing, wherein the housing includes an inlet, and an outlet; and a pressure reducing mechanism, wherein the pressure reducing mechanism is connected to the housing, wherein the pressure reducing mechanism is contained within the housing, wherein the pressure reducing mechanism is disposed between the inlet and the outlet, and wherein the pressure reducing mechanism is configured to receive a fluid having an first pressure which enters via the inlet, direct a flow of the fluid to the outlet at a second pressure, wherein the second pressure is lower than the first pressure.

In some embodiments, a fluid supply system comprises a container body, wherein the container body defines an internal cavity for storing a fluid at a first pressure; and a pressure regulator device, wherein the pressure regulator device is disposed in the internal cavity, wherein the pressure regulator device is a single unitary body, wherein the single unitary body includes a housing, wherein the housing includes an inlet, and an outlet; and a pressure reducing mechanism, wherein the pressure reducing mechanism is contained within the housing, wherein the pressure reducing mechanism is disposed between the inlet and the outlet, and wherein the pressure reducing mechanism is configured to receive the fluid having the first pressure which enters via the inlet, direct a flow of the fluid to the outlet at a second pressure, wherein the second pressure is lower than the first pressure.

In some embodiments, the fluid supply system, further comprises a second pressure regulator device, wherein an inlet of the second pressure regulator device is connected to the outlet of the pressure regulator device.

In some embodiments of the fluid supply system, the second pressure regulator device is disposed in the internal cavity, wherein the pressure regulator device is another single unitary body, wherein the another single unitary body includes a second housing, wherein the second housing includes a second inlet, and a second outlet; and a second pressure reducing mechanism, wherein the second pressure reducing mechanism is contained within the second housing, wherein the second pressure reducing mechanism is disposed between the second inlet and the second outlet, and wherein the second pressure reducing mechanism is configured to receive the fluid having the second pressure which enters via the second inlet, direct a flow of the fluid to the second outlet at a third pressure, wherein the third pressure is lower than the second pressure.

In some embodiments, the fluid supply system, further comprises a filter device connected to the inlet of the pressure regulator device.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a schematic diagram of a non-limiting embodiment a subatmospheric pressure delivery system having one or more PSUD described herein.

FIG. 2A depicts a perspective view of a non-limiting embodiment of the PSUD described herein.

FIG. 2B depicts a side view of the non-limiting embodiment shown in FIG. 2A.

FIG. 3A depicts a perspective cross-sectional view of the non-limiting embodiment of the PSUD shown in FIGS. 2A and 2B.

FIG. 3B depicts a side cross-sectional view of the non-limiting embodiment of the PSUD shown in FIG. 3A.

FIG. 4 depicts a perspective view of a non-limiting embodiment of the PSUD described herein.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things.

Accordingly, in any one or more of the embodiments disclosed herein, a particular structural portion being disposed between two other structural elements can be:
disposed directly between both of the two other structural elements such that the particular structural portion is in direct contact with both of the two other structural elements;
disposed directly next to only one of the two other structural elements such that the particular structural portion is in direct contact with only one of the two other structural elements;
disposed indirectly next to only one of the two other structural elements such that the particular structural portion is not in direct contact with only one of the two other structural elements, and there is another element which juxtaposes the particular structural portion and the one of the two other structural elements;
disposed indirectly between both of the two other structural elements such that the particular structural portion is not in direct contact with both of the two other structural elements, and other features can be disposed therebetween; or
any combination(s) thereof.

As used herein, the term “unitary device” means a device which has been formed or constructed unitarily via an additive manufacturing process(es) (e.g., 3D printing). Accordingly, the “unitary device” is made of a material which is capable of being additively manufactured. Examples of such material includes polymers, metals, stainless steel, composite materials, or combinations thereof.

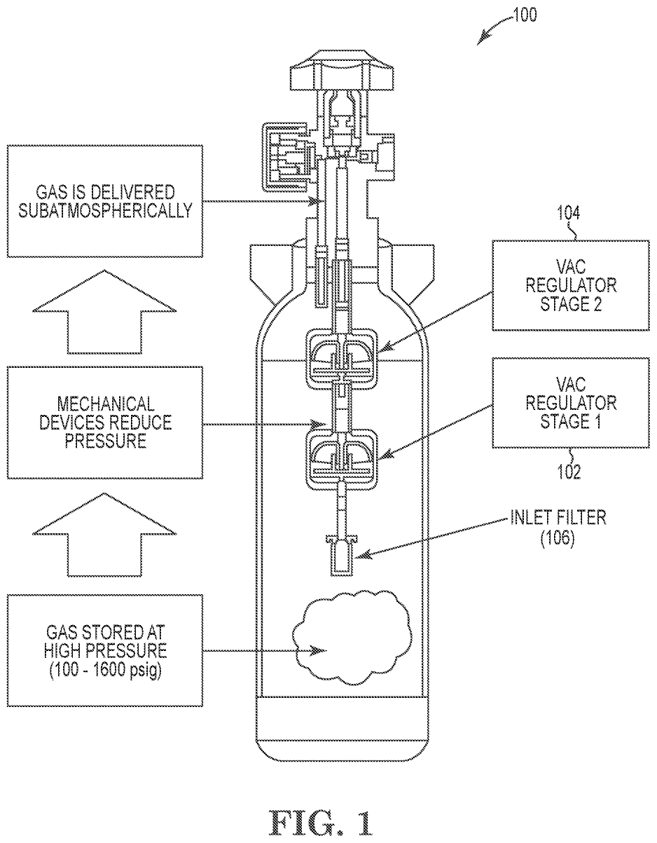

FIG. 1 depicts a schematic diagram of a non-limiting embodiment a subatmospheric pressure delivery system 100 having mechanical devices 102, 104 configured to reduce pressure of a fluid so that the output of the fluid is at a subatmospheric pressure. The mechanical devices 102, 104 include a first VAC regulator 102 at stage 1 and a second VAC regulator 104 at stage 2. Each of the VAC regulators 102, 104 can be or include a PSUD described herein. The first VAC regulator 102 is connected to an inlet filter device 106, and also to the second VAC regulator 104. The system 100 shown in FIG. 1 has the inlet filter device 106, the first VAC regulator 102, and the second VAC regulator 104 in line as a serial connection. Thus, a fluid which is stored at a high pressure, such as for example, 100-1600 psig, flows into the inlet filter 106, and then passes through the first VAC regulator 102, and the second VAC regulator 104, wherein the VAC regulators 102, 104 reduce the pressure of the fluid, and the fluid can be delivered out of the system 100 at subatmospheric pressure.

In some embodiments, each of the mechanical devices 102, 104 is a unitary device. Accordingly, the two unitary devices 102, 104 can be joined together as depicted in the exemplary embodiment shown in FIG. 1.

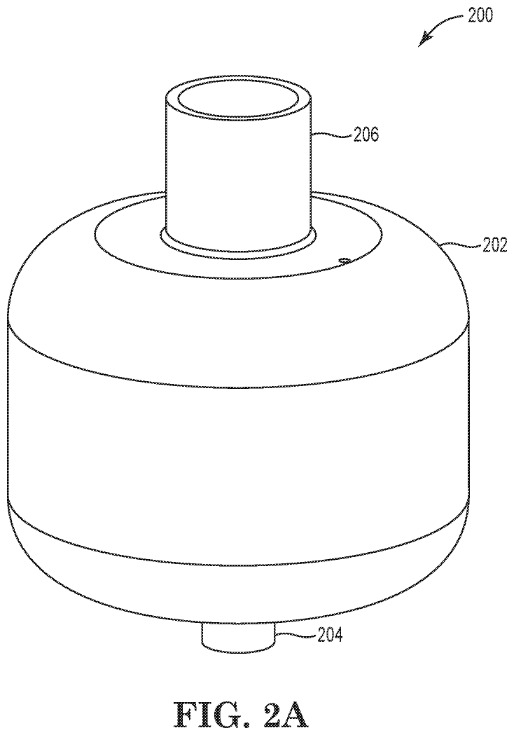

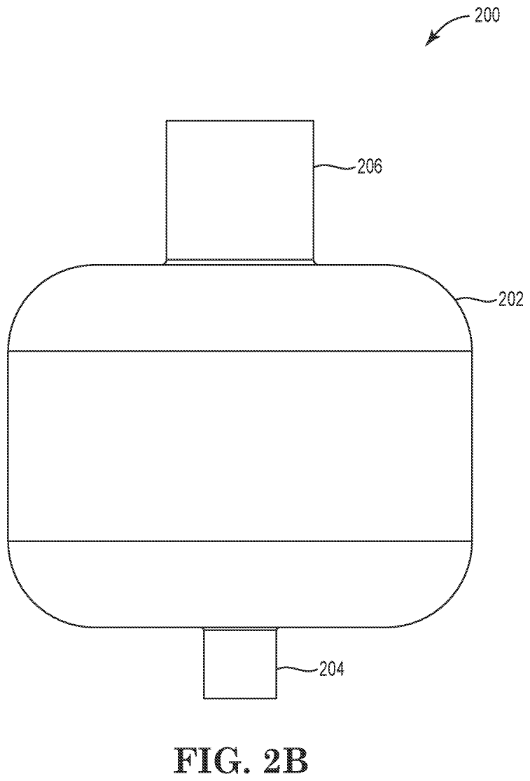

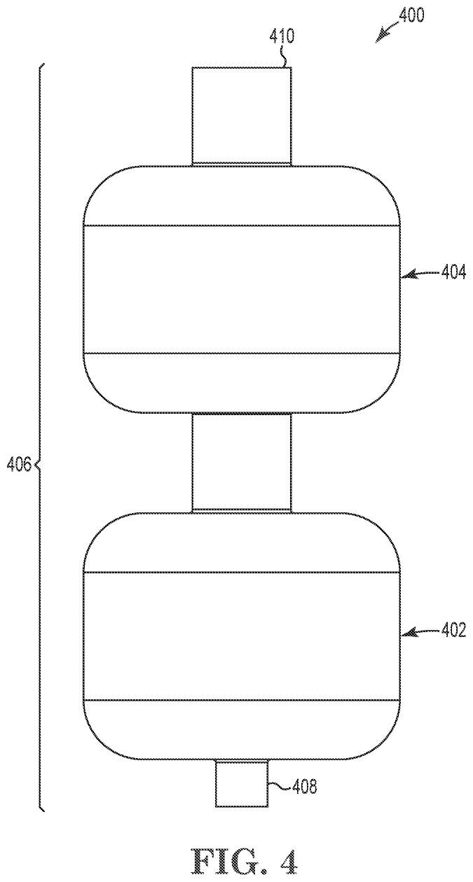

FIG. 2A shows a perspective view of a non-limiting embodiment of the PSUD 200. FIG. 2B shows a side view of the PSUD 200. The PSUD 200 has a housing 202 with an inlet 204 and an outlet 206. The inlet 204 receives a high pressure fluid and directs the fluid to flow into the inner cavity of the housing 202. The outlet 206 expels a lower pressure fluid (as compared to the high pressure fluid received via the inlet 204) out of the housing 202. It will be understood that, according to some embodiments, two or more PSUDs can be formed together in a single housing (e.g., see FIGS. 1 and 4).

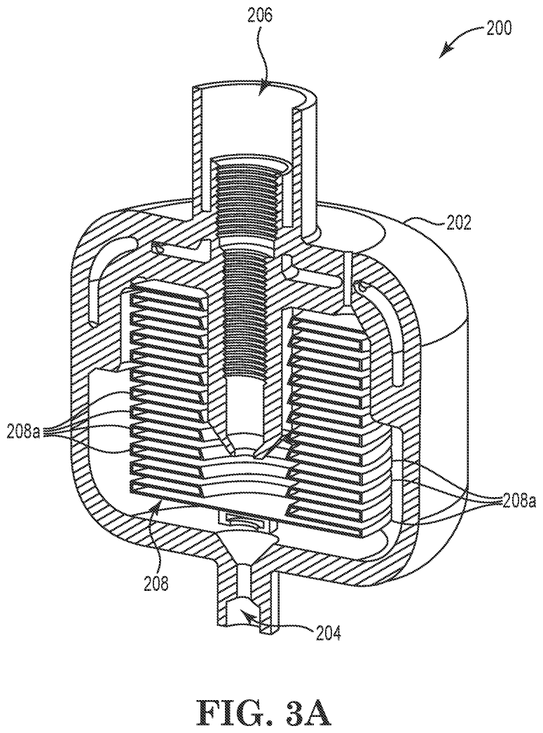

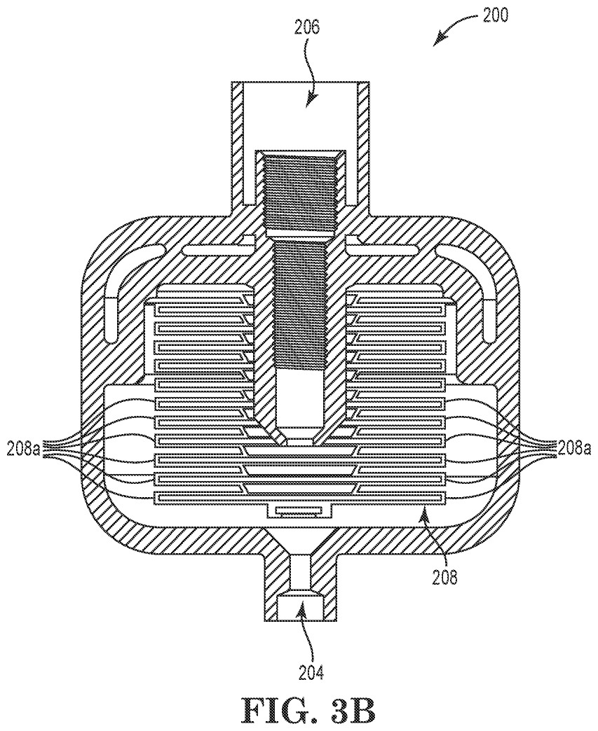

FIG. 3A shows a perspective cross-sectional view of the PSUD 200 shown in FIGS. 2A and 2B. FIG. 3B shows a side cross-sectional view of the PSUD 200. The PSUD 200 has a housing 202 and other components made of a single unitary body. The housing 202 is a unitary device having a single unitary body. The housing 202 defines an internal cavity (or cavities). A pressure regulating (or reducing) portion 208 is contained within the internal cavity of the housing 202. Other various portions are defined by the internal structure(s) of the housing 202 and the pressure regulating portion 208, and configured to direct flow of a fluid within the internal cavity of the housing 202. These various portions, such as flow paths and the pressure regulating portion 208 are still a single unitary device with the housing 202, wherein all of the portions shown in FIGS. 3A and 3B are formed together via, e.g., additive manufacturing process. Accordingly, none of the components and structures shown in FIGS. 3A and 3B are separate components that require welding to connect them together. The internal structures and the pressure regulating portion 208 are formed along with the housing 202 such that the internal structures shown in FIGS. 3A and 3B are encased and enclosed by the housing 202 at the completion of the manufacturing process.

FIGS. 3A and 3B show, as an example, the pressure regulating portion 208 being bellows 208, wherein the bellows 208 has a plurality of leaves 208a that operate mechanically to reduce pressure of a fluid (e.g., gas) from the inlet 204 and expel the fluid towards the outlet 206. The bellows 208 is configured to have substantially consistent pressure at the outlet 206, reduce fluid pressure spikes at the outlet 208, or both. Both the housing 202 and the bellows 208 can be made of appropriate material, such as a metal, such as, for example, stainless steel.

In some embodiments, the mechanical devices (102, 104 shown in FIG. 1) together is a unitary device, PSUD 400. As shown in FIG. 4, in such embodiments of the PSUD 400, there are two portions 402, 404 (internal structure not shown, but are similar to those shown in, for example, FIGS. 2A-3B) contained serially in a single housing 406, where in the housing 406 and the two pressure portions 402, 404 are formed from a single unitary body. Such single unitary body can be made via, for example, additive manufacturing process.

Accordingly, the PSUD 400 does not require multiple components that are assembled after the manufacturing of such multiple components. Thus, the PSUD 400 does not include any welds, and does not require any welding of multiple components. In some embodiments, each of the portions 402, 404 include independently operating, but yet still connected as a unitary device, bellows portion as shown in FIGS. 2A-3B. Thus, a fluid can enter via the inlet 408, travel through the internal bellows portions of the portion 402, and then travel through the internal bellows portions of the portion 404, and then travel out via the outlet 410. While FIG. 4 shows two portions 402, 404, it will be understood that, in some embodiments of the PSUD, there can be more than two portions in serial, in parallel, or any combinations thereof.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A device comprising:
a single unitary body comprising:
a housing that includes an inlet and an outlet. a pressure reducing mechanism that is contained with the housing and is,
disposed between the inlet and the outlet, and
wherein the pressure reducing mechanism is configured to receive a fluid having a first pressure which enters via the inlet, direct a flow of the fluid towards the outlet at a second pressure.

2. The device of claim 1, wherein the housing and the pressure reducing mechanism does not have any welds or welded components.

3. The device according to claim 1, wherein the pressure reducing mechanism includes a bellows portion.

4. The device of claim 3, wherein the single unitary body is made of a stainless steel.

5. The device according to claim 1, wherein the single unitary body further comprises:
a second pressure reducing mechanism,
wherein the pressure reducing mechanism is contained within the housing,
wherein the pressure reducing mechanism is disposed between the pressure reducing mechanism and the outlet, and
wherein the pressure reducing mechanism is configured to receive the fluid from the pressure reducing mechanism having the second pressure, and then direct the flow of the fluid towards the outlet at a third pressure.

6. The device according to claim 1, wherein the first pressure is higher than subatmospheric pressure.

7. The device according to claim 1, wherein the second pressure is subatmospheric pressure.

8. The device according to claim 1, wherein the second pressure is lower than the first pressure.

9. A device comprising:
a single unitary body,
wherein the single unitary body consists of:
a housing,
wherein the housing includes:
an inlet, and
an outlet; and
a pressure reducing mechanism,
wherein the pressure reducing mechanism is connected to the housing,
wherein the pressure reducing mechanism is contained within the housing,
wherein the pressure reducing mechanism is disposed between the inlet and the outlet, and
wherein the pressure reducing mechanism is configured to receive a fluid having an first pressure which enters via the inlet, direct a flow of the fluid to the outlet at a second pressure,
wherein the second pressure is lower than the first pressure.

10. The device of claim 9, wherein the housing and the pressure reducing mechanism does not have any welds or welded components.

11. The device according to claim 9, wherein the pressure reducing mechanism includes a bellows portion.

12. The device of claim 11, wherein the single unitary body is made of a stainless steel.

13. The device according to claim 9, wherein the first pressure is not subatmospheric pressure.

14. The device according to claim 9, wherein the first pressure is higher than subatmospheric pressure.

15. The device according to claim 9, wherein the second pressure is subatmospheric pressure.

16. The device according to claim 9, wherein the second pressure is lower than the first pressure.

17. A fluid supply system comprising:
a container body,
wherein the container body defines an internal cavity for storing a fluid at a first pressure; and
a pressure regulator device,
wherein the pressure regulator device is disposed in the internal cavity,
wherein the pressure regulator device is a single unitary body,
wherein the single unitary body includes:
a housing,
wherein the housing includes:
an inlet, and
an outlet; and
a pressure reducing mechanism,
wherein the pressure reducing mechanism is contained within the housing,
wherein the pressure reducing mechanism is disposed between the inlet and the outlet, and
wherein the pressure reducing mechanism is configured to receive the fluid having the first pressure which enters via the inlet, direct a flow of the fluid to the outlet at a second pressure, wherein the second pressure is lower than the first pressure.

18. The fluid supply system of claim 17, further comprising a second pressure regulator device, wherein an inlet of the second pressure regulator device is connected to the outlet of the pressure regulator device.

19. The fluid supply system of claim 18,
wherein the second pressure regulator device is disposed in the internal cavity,
wherein the pressure regulator device is another single unitary body,
wherein the another single unitary body includes:
a second housing,
wherein the second housing includes:
a second inlet, and
a second outlet; and
a second pressure reducing mechanism,
wherein the second pressure reducing mechanism is contained within the second housing,
wherein the second pressure reducing mechanism is disposed between the second inlet and the second outlet, and
wherein the second pressure reducing mechanism is configured to receive the fluid having the second pressure which enters via the second inlet, direct a flow of the fluid to the second outlet at a third pressure, wherein the third pressure is lower than the second pressure.

20. The fluid supply system according to claim 9, further comprising a filter device connected to the inlet of the pressure regulator device.
